(19) United States
(12) Patent Application Publication
(10) Pub. No.: US 2003/0110511 A1
(43) Pub. Date: Jun. 12, 2003

(54) Controlling personal video recording functions from interactive television

(76) Inventors: Mark E. Schutte, Suwanee, GA (US); Valerie G. Gutknecht, Woodstock, GA (US)

Correspondence Address: SCIENTIFIC-ATLANTA, INC., INTELLECTUAL PROPERTY DEPARTMENT, 5030 SUGARLOAF PARKWAY, LAWRENCEVILLE, GA, 30044, US

(21) Appl. No.: 10/015,349

(22) Filed: Dec. 11, 2001

(51) Int. Cl. H04N 9/79; H04N 11/04; H04N 7/20; H04N 7/173; H04N 5/91; H04N 7/08; H04N 1/00; H04N 7/16

(52) U.S. Cl. 725/131; 725/139; 725/151; 386/92; 386/40; 386/124

(57) ABSTRACT

An interactive media system includes a memory with logic and a processor configured with the logic to effect receiving first media content, transitioning from the first media content to second media content, and recording the first media content responsive to transitioning.

### TECHNICAL FIELD

The invention is generally related to television systems, and, more particularly, to interactive television.

### BACKGROUND OF THE INVENTION

With recent advances in digital transmission technology, subscriber television systems are now capable of providing much more than the traditional analog broadcast video. In implementing enhanced programming, the home communication terminal device (“HCT”), otherwise known as the set-top box, has become an important computing device for accessing media content services (and media content within those services) and navigating a user through a maze of available services. In addition to supporting traditional analog broadcast video functionality, digital HCTs (or “DHCTs”) now also support an increasing number of two-way digital services such as video-on-demand and personal video recording.

Typically, a DHCT is connected to a cable or satellite, or generally, a subscriber television system, and includes hardware and software necessary to provide the functionality of the digital television system at the user's site. Preferably, some of the software executed by a DHCT is downloaded and/or updated via the subscriber television system. Each DHCT also typically includes a processor, communication components, and memory, and is connected to a television or other display device, such as a personal computer. While many conventional DHCTs are stand-alone devices that are externally connected to a television, a DHCT and/or its functionality may be integrated into a television or personal computer or even an audio device such as a programmable radio, as will be appreciated by those of ordinary skill in the art.

As more and more services and applications are provided, subscriber television system are providing media content information to the DHCT so that the user can view such information on the display connected to the DHCT or a remote device such as the television. The media content information allows the viewer to learn more about the available media content, or content (e.g. movies, songs, web pages, etc.). However, because of the large variety of media content choices, and the vast media content information associated with the media content choices, viewing conflicts arise. Therefore, there exists a need to reduce viewing conflicts.

Thus, a heretofore unaddressed need exists in the industry to address the aforementioned deficiencies and inadequacies.

### BRIEF DESCRIPTION OF THE DRAWINGS

The preferred embodiments of the invention can be better understood with reference to the following drawings. The components in the drawings are not necessarily to scale, emphasis instead being placed upon clearly illustrating the principles of the invention. Moreover, in the drawings, like reference numerals designate corresponding parts throughout the several views.

FIG. 1A is a block diagram of an example subscriber television system (STS), in accordance with one embodiment of the invention.

FIG. 1B shows a block diagram of the transmission signals supported by the STS of FIG. 1A, and input into the digital home communication terminal (DHCT) from the headend, in accordance with one embodiment of the invention.

FIG. 2 is a block diagram of an example headend as depicted in FIG. 1A and related equipment, in accordance with one embodiment of the invention.

FIG. 3A is a block diagram of an example DHCT as depicted in FIG. 1A and related equipment, in accordance with one embodiment of the invention.

FIG. 3B is a block diagram of an example hard disk and hard disk elements located within the storage device coupled to the DHCT depicted in FIG. 3A, in accordance with one embodiment of the invention.

FIG. 3C is a diagram of an example remote control device to provide input to the DHCT 16 illustrated in FIG. 3A, in accordance with one embodiment of the invention.

FIG. 4 is a screen diagram of an example screen display showing a movie in progress and the presentation of a “bug”, in accordance with one embodiment of the invention.

FIG. 5 is a screen diagram of an example web page resulting from the user responding affirmatively to the “bug” presented in the example screen display of FIG. 4, in accordance with one embodiment of the invention.

FIGS. 6A-6C are block diagrams of example Application Programming Interfaces (APIs) to invoke automatic recording and playback functionality, in accordance with one embodiment of the invention.

FIG. 7 is a screen diagram of an example screen display presenting a graphics user interface (GUI) that provides a user with selectable options upon exiting from the web-page of FIG. 5, in accordance with one embodiment of the invention.

FIG. 8 is a screen diagram of an example screen display presented automatically upon exiting from the web page depicted in FIG. 5, or upon selecting to view the missed content from the GUI of FIG. 7, wherein the example screen display illustrates a mechanism for providing feedback to a user relating where the playback position is relative to the active recording position, in accordance with one embodiment of the invention.

### DETAILED DESCRIPTION OF THE PREFERRED EMBODIMENTS

The preferred embodiments of the invention now will be described more fully hereinafter with reference to the accompanying drawings, in which preferred embodiments of the invention are shown. The invention may, however, be embodied in many different forms and should not be construed as limited to the embodiments set forth herein; rather, these embodiments are provided so that this disclosure will be thorough and complete, and will fully convey the scope of the invention to those skilled in the art. Furthermore, all “examples” given herein are intended to be non-limiting, and among others.

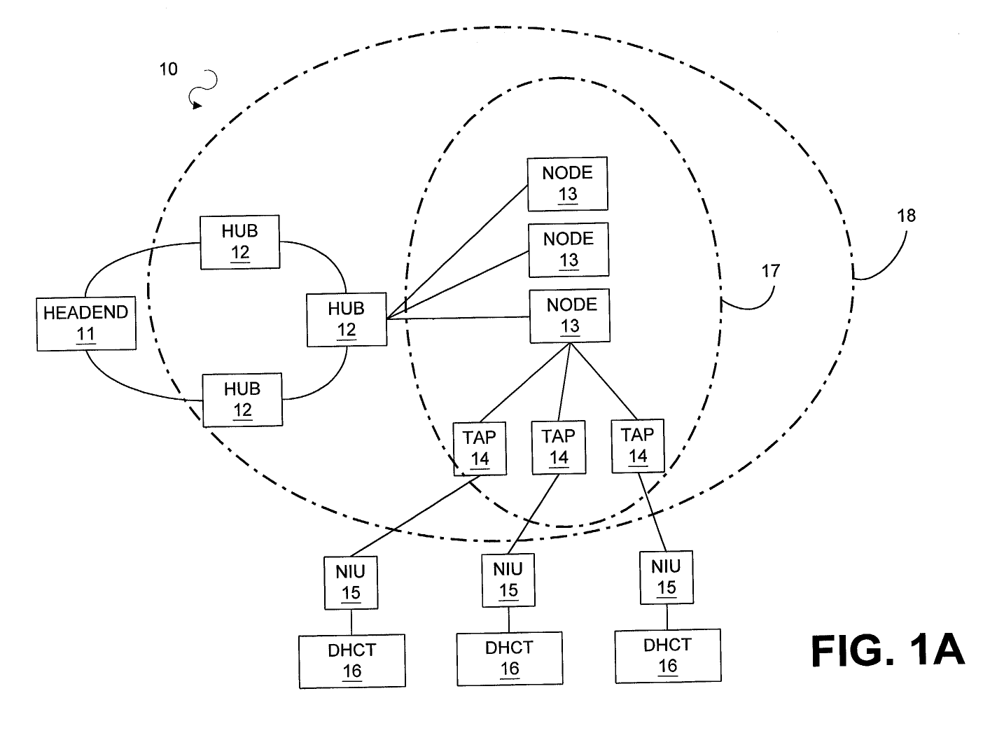

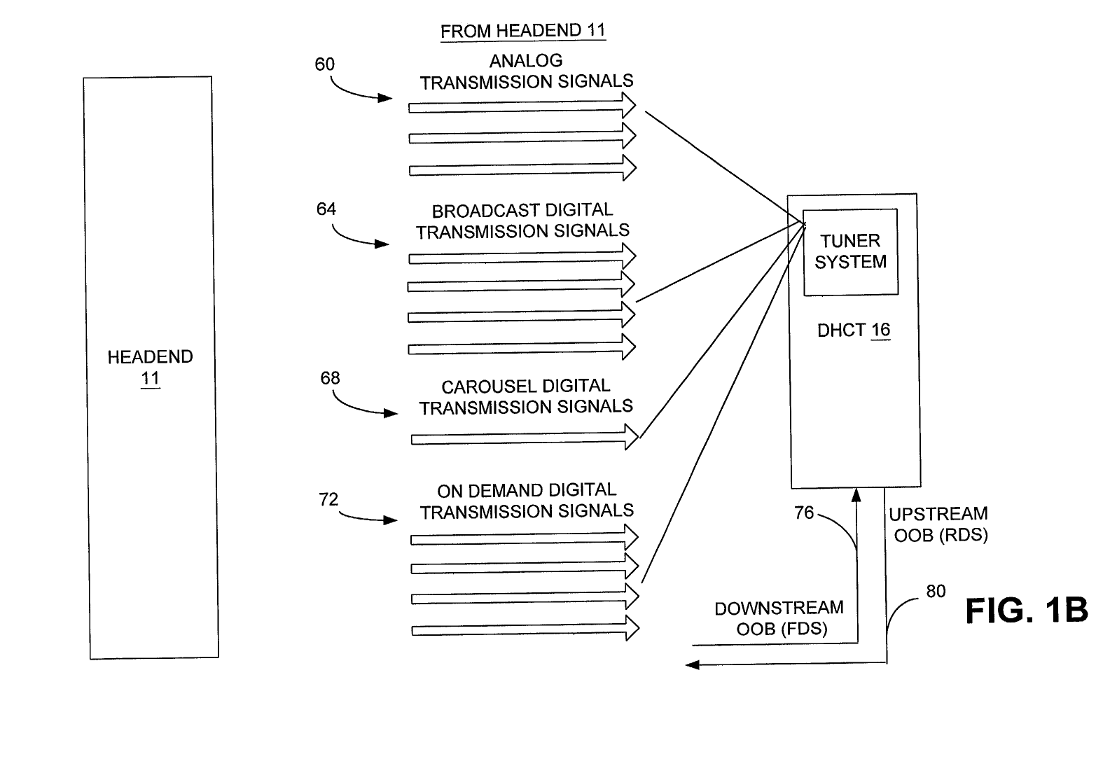

One embodiment of the invention is generally implemented as part of a subscriber television system such as a digital broadband delivery system (DBDS) or cable television system (CTS). For example, a subscriber television system (STS) and its operation will be described initially, with the understanding that other conventional data delivery systems are within the scope of the preferred embodiments of the invention. FIG. 1A shows a block diagram view of a subscriber television system (STS) 10, which is generally a high quality, reliable and integrated network system that is preferably capable of delivering video, audio, voice and data services to digital home communication terminals (DHCTs) 16. Although FIG. 1A depicts a high level view of a STS 10, it should be appreciated that a plurality of subscriber television systems can tie together a plurality of regional networks into an integrated global network so that DHCT users can receive media content provided from anywhere in the world. Further, it will be appreciated that the STS 10 shown in FIG. 1A is merely illustrative and should not be construed as implying any limitations upon the scope of the preferred embodiments of the present invention. For instance, subscriber television systems also included within the scope of the preferred embodiments of the invention include systems not utilizing physical structured cabling for transmission, such as, but not limited to, satellite systems. Further, transmission media included within the scope of the preferred embodiments of the invention include, but are not limited to, hybrid fiber/coax (HFC), optical, satellite, radio frequency (RF), frequency modulated (FM), and microwave. Further, data provided from the headend 11 to the DHCTs 16 and programming necessary to perform the functions discussed below will be understood to be present in the STS 10, in accordance with the description below.

The STS 10 preferably delivers broadcast video signals as digitally formatted signals in addition to delivering traditional broadcast analog video signals. Furthermore, the system preferably supports one way broadcast services as well as both one-way data services and two-way media content and data services (herein, media content will be understood to mean media content, data, or a combination of media content and data). The two-way operation of the network preferably allows for user interactivity with services, such as Pay-Per-View programming, Near Video-On-Demand (NVOD) programming according to any of several known NVOD implementation methods, Video-on-Demand (VOD) programming (according to any of several VOD implementation methods), and interactive applications, such as Internet connections.

The STS 10 also provides the interfaces, network control, transport control, session control, and servers to access media content from media content services, and distributes media content to DHCT users. As shown in FIG. 1A, a typical STS 10 comprises a headend 11, hubs 12, an HFC access network 17, and DHCTs 16. It should be appreciated that although a single component (e.g. a headend) is illustrated in FIG. 1A, a STS 10 can feature a plurality of any one of the illustrated components or may be configured with alternative embodiments for any one of the individual components or with yet other additional components not enumerated above.

Media content provided by one or more content providers (not shown) is communicated by the content providers to one or more headends 11. From those headends 11 the media content is then communicated over a communications network 18 that includes a plurality of HFC access networks 17 (only one HFC access network 17 is illustrated). The HFC access network 17 typically comprises a plurality of HFC nodes 13, each of which may serve a local geographical area. The hub 12 connects to the HFC node 13 through a fiber portion of the HFC access network 17. The HFC node 13 is connected to a tap 14 which, in one implementation, is connected to a network interface unit (NIU) 15 which is connected to a digital home communication terminal (DHCT) 16. In other implementations, the HFC node 13 is connected directly to a DHCT 16. The NIU 15, when implemented, is normally located at the property of a user and provides a transparent interface between the HFC node 13 and said property internal wiring. Coaxial cables are typically used to couple nodes 13, taps 14 and NIUs 15 because the electrical signals can be easily repeated with RF amplifiers. As the high-level operations of many of the functions of a subscriber television system (STS) 10 are well known to those of ordinary skill in the art, further high level description of the overall STS 10 of FIG. 1A will not be contained herein.

FIG. 1B is a block diagram illustrating the transmission signals supported by the STS 10 (FIG. 1A), where the transmission signals 60, 64, 68, 72 and 76 are input into a DHCT 16 in accordance with one embodiment of the invention. These transmission signals are mostly provided by one or more content providers (not shown). Transmission signals can be generated at a headend 11 or at a hub 12 (FIG. 1A) that might function as a mini-headend and which therefore possesses some of the headend functionality. As depicted in FIG. 1B, the STS 10 can simultaneously support a number of transmission signal types, transmission rates, and modulation formats. The ability to carry analog and digital signals over a large bandwidth are characteristics of a HFC Network typically employed in a STS, as in the STS 10 of FIG. 1A. As will be appreciated by those of ordinary skill in the art, analog and digital signals in HFC networks can be multiplexed using Frequency Division Multiplexing (FDM), which enables many different types of signals to be transmitted over the STS 10 to the DHCT 16. Typically, a STS 10 using HFC supports downstream (i.e., in the direction from the headend 11 to the DHCT 16) frequencies from 50 MHz to 870 MHz, whereas upstream frequencies (i.e., in the direction from the DHCT 16 to higher levels of the system) are in the 5 MHz to 42 MHz band. Generally, the radio frequency (RF) bandwidth spacing for analog and digital services is 6 MHz. Furthermore, for a typical 870 MHz system in the U.S., a possible downstream RF spectrum subdivision plan uses 6 MHz frequency subdivisions, or spans, within the 50 MHz to 550 MHz band for analog video transmission signals and within the 550 MHz to 870 MHz range for digital transmission signals. Referring again to FIG. 1B, the downstream direction transmission signals, having been multiplexed, and in one embodiment using frequency division multiplexing (FDM), are often referred to as in-band transmission signals and include Analog Transmission Signals (ATSs) 60 and Digital Transmission Signals (DTSs) 64, 68, 72 (also known as Digital Transport Signals). These transmission signals carry video, audio and data services. For example, these transmission signals may carry television signals, Internet data, or any additional types of data, such as Electronic Program Guide (EPG) data. The ATSs 60 shown in FIG. 1B are typically broadcast in 6 MHz frequency subdivisions, typically referred to in analog broadcasting as channels, having an analog broadcast signal composed of analog video and analog audio, and include Broadcast TV Systems Committee (BTSC) stereo and Secondary Audio Program (SAP) audio. Additionally, as will be appreciated by those of ordinary skill in the art, additional data can be sent with the analog video image in the Vertical Blanking Interval (VBI) of the video signal and stored in DHCT memory or a DHCT local physical storage device (not shown). It should be appreciated, however, that the amount of data that can be transmitted in the VBI of the analog video signal is typically significantly less than data transmitted in a DTS.

Like the ATSs 60, the DTSs 64, 68, 72 each occupies 6 MHz of the RF spectrum. However, the DTSs 64, 68, 72 are digital transmission signals consisting of 64- or 256-Quadrature Amplitude Modulated (QAM) digital signals formatted as MPEG-2 transport streams, allocated in a separate frequency range. As will be described in more detail below, the MPEG-2 transport stream enables transmission of a plurality of DTS types over each 6 MHz RF subdivision, as compared to a 6 MHz ATS. The three types of digital transport signals illustrated in FIG. 1B include broadcast digital transmission signals 64, carousel digital transmission signals 68, and on-demand transmission signals 72.

MPEG-2 transport may be used to multiplex video, audio, and data in each of these Digital Transmission Signals (DTSs). However, because an MPEG-2 transport stream allows for multiplexed video, audio, and data into the same stream, the DTSs do not necessarily have to be allocated in separate 6 MHz RF frequencies, unlike ATSs 60. On the other hand, each DTS is capable of carrying multiple broadcast digital video media content instances, multiple cycling data carousels containing broadcast data, and data requested on-demand by the subscriber. Data is formatted, such as in Internet Protocol (IP), mapped into MPEG-2 packets, and inserted into the multiplexed MPEG-2 transport stream. Encryption can be applied to the data stream for security so that the data may be received only by authorized DHCTs. The authorized DHCT 16 is provided with the mechanisms to receive, among other things, additional data or enhanced services. Such mechanisms can include “keys” that are required to decrypt encrypted data.

Each 6 MHz RF subdivision assigned to a digital transmission signal can carry the video and audio streams of the media content instances of multiple television (TV) stations, as well as media content and data that is not necessarily related to those TV media content instances, as compared to one TV channel broadcast over one ATS 60 that consumes the entire 6 MHz. The digital data is inserted into MPEG transport streams carried through each 6 MHz frequency subdivision assigned for digital transmission, and then demultiplexed at the subscriber DHCT so that multiple sets of data can be produced within each tuned 6 MHz frequency span, or subdivision.

Although broadcast in nature, the carousel DTSs 68 and on-demand DTSs 72 offer different functionality. Continuing with FIG. 1B, the broadcast DTSs 64 and carousel DTSs 68 typically function as continuous feeds for indefinite time, whereas the on-demand DTSs 72 are continuous feeds sessions for a limited time. All DTS types are capable of being transmitted at high data rates. The broadcast DTSs 64 carry typical data comprising multiple digitally-MPEG-2 compressed and formatted TV source signals and other continuously fed data information. The carousel DTSs 68 carry broadcast media content or data that is systematically broadcast in a cycling fashion but updated and revised as needed. Thus, the carousel DTSs 68 serve to carry high volume data such as media content and data and possibly, other data at high data rates. The carousel DTSs 68 preferably carry data formatted in directories and files by a Broadcast File System (BFS) (not shown), which is used for producing and transmitting data streams throughout the STS 10 (FIG. 1A), and which provides an efficient means for the delivery of application executables and application media content and data to the DHCT, as will be described below. Media content and data received by the DHCT 16 in such manner can then be saved in the DHCT memory and/or transferred to the DHCT storage device for later use. The on-demand DTSs 72, on the other hand, can carry particular information such as compressed video and audio pertaining to subscriber requested media content instance preview and/or media content instance descriptions, as well as other specialized data information.

The User-to-Network Download Protocol of the MPEG-2 standard's DSM-CC specification (Digital Storage Media—Command and Control) provides the data carousel protocol used for broadcasting data from one or more servers located at the headend 11, or elsewhere. It also provides the interactive download protocol for reliable downloading of data from a server (possibly the same server) to an individual DHCT through the on-demand DTSs. Each carousel and on-demand DTS is defined by a DSM-CC session. Therefore, some of the basic functionality reflected in the DHCT 16 when the DHCT does not have a local physical storage device is somewhat similar to a networked computer (i.e., a computer without a persistent storage device), in addition to traditional set top box functionality, as is well known to those of ordinary skill in the art. A DHCT 16 with a storage device reduces data access latency when the data is stored in the local physical storage device ahead of time.

Also shown in FIG. 1B are Out-Of-Band (OOB) signals that provide continuously available two-way signaling to the subscribers' DHCT 16 regardless of which in-band signals are tuned to by the individual DHCT in-band tuners, as described below. The OOB signals consist of a Forward Data Signal (FDS) 76 and a Reverse Data Signal (RDS) 80. The OOB signals can comply to any one of a number of well known transport protocols but preferably comply to either a DAVIC 1.1 Transport Protocol with FDS of 1.544 mega-bits per second (Mbps) or more using quadrature phase shift keying (QPSK) modulation and an RDS of 1.544 Mbps or more using QPSK modulation, or to a DOCSIS Transport Protocol with FDS of 27 Mbps using 64-QAM modulation and a RDS of 1.544 Mbps or more using QPSK modulation or 16-QAM modulation. The OOB signals provide the two-way operation of the network, which allows for subscriber interactivity with the applications and services provided by the network. Furthermore, the OOB signals are not limited to a 6 MHz spectrum, but generally to a smaller spectrum, such as 1.5 or 3 MHz.

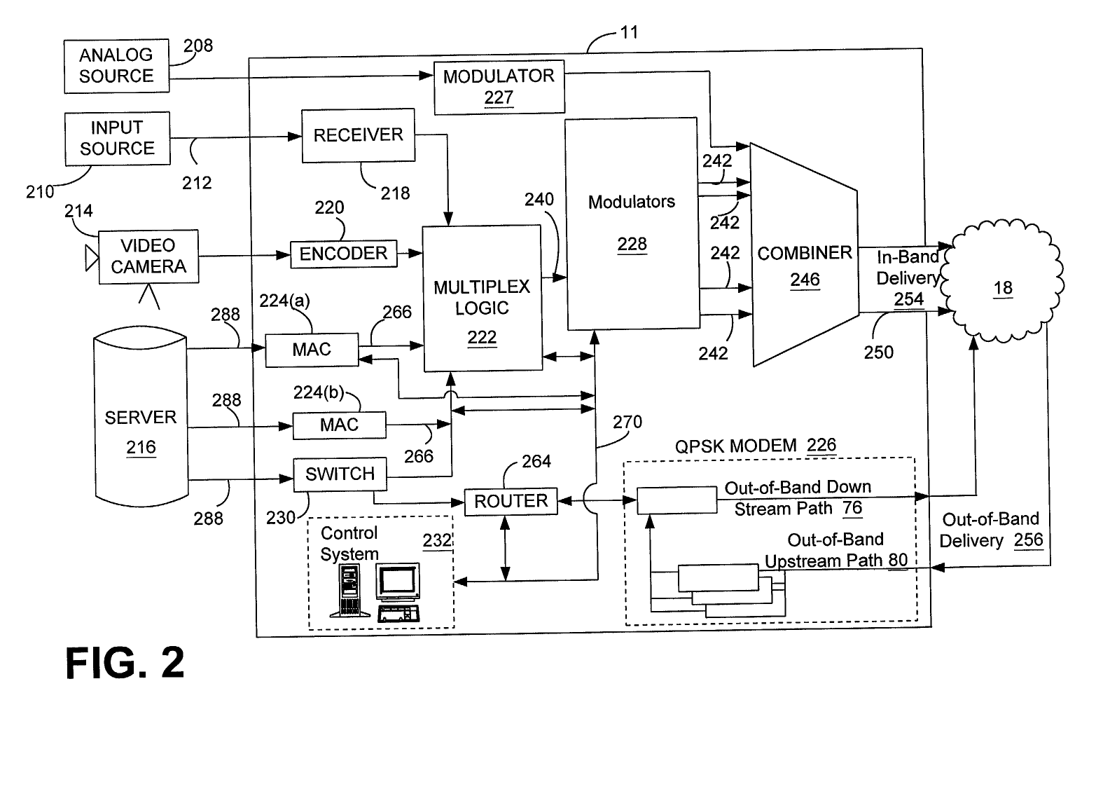

FIG. 2 is an overview of a headend 11, which provides the interface between the STS 10 (FIG. 1A) and the service and content providers. The overview of FIG. 2 is equally applicable to a hub 12, and the same elements and principles may be implemented at a hub 12 instead of the headend 11 as described herein. It will be understood that the headend 11 shown in FIG. 2 is merely illustrative and should not be construed as implying any limitations upon the scope of the preferred embodiments of the invention. The headend 11 receives content from a variety of service and content providers, which can provide input in a variety of ways. The headend 11 combines the content from the various sources and distributes the content to subscribers via the distribution systems of the network 18.

In a typical system, the programming, services and other information from content providers can be distributed according to a variety of mechanisms. The input signals may be transmitted from sources to the headend 11 via a variety of transmission paths, including satellites (not shown), and terrestrial broadcast transmitters and antennas (not shown). The headend 11 can also receive content from a direct feed source 210 via a direct line 212. Other input sources from content providers include a video camera 214, analog input source 208, or an application server 216. The application server 216 may include more than one line of communication. One or more components such as analog input source 208, input source 210, video camera 214, and application server 216 can be located external to the headend 11, as shown, or internal to the headend 11 as would be appreciated by one having ordinary skill in the art. The signals provided by the content or programming input sources can include a single media content instance (i.e. individual instances of media content such as an episode of a television show, a movie, or web-page, etc.) or a multiplex that includes several media content instances.

The headend 11 generally includes one or more receivers 218 that are each associated with a content source. MPEG encoders, such as encoder 220, are included for digitally encoding at least some local programming or a real-time feed from video camera 214, or the like. The encoder 220 outputs the respective compressed video and audio streams corresponding to the analog audio/video signal received at its input. For example, encoder 220 can output formatted MPEG-2 or MPEG-1 packetized elementary (PES) streams or transport streams compliant to the syntax and semantics of the ISO MPEG-2 standard, respectively. The PES or transport streams may be multiplexed with input signals from switch 230, receiver 218 and control system 232. The multiplexing logic 222 processes the input signals and multiplexes at least a portion of the input signals into transport stream 240. Analog input source 208 can provide an analog audio/video broadcast signal which can be input into modulator 227. From modulator 227, a modulated analog output signal can be combined at combiner 246 along with other modulated signals for transmission into transmission medium 250. Alternatively, analog audio/video broadcast signal from analog input source 208 can be input into modulator 228. Alternatively, analog audio/video broadcast signal can be input directly from modulator 227 to transmission medium 250. The analog broadcast media content instances are transmitted via respective radio-frequency (RF) channels, each assigned for transmission of an analog audio/video signal such as NTSC video, as described in association with FIG. 1B.

The switch, such as asynchronous transfer mode (ATM) switch 230, provides an interface to an application server 216. There can be multiple application servers 216 providing a variety of services such as a Pay-Per-View service, including video on demand (VOD), a data service, an Internet service, a network system, or a telephone system. Service and content providers may download content to an application server located within the STS 10 (FIG. 1A). The application server 216 may also be located within the headend 11 or elsewhere within the STS 10, such as in a hub 12. The various inputs into the headend 11 are then combined with the other information from the control system 232, which is specific to the STS 10, such as local programming and control information, which can include among other things conditional access information. The headend 11 contains one or more modulators 228 to convert the received transport streams 240 into modulated output signals suitable for transmission over the transmission medium 250 through the network 18. Each modulator 228 may be a multimodulator including a plurality of modulators, such as, but not limited to, QAM modulators, that radio frequency modulate at least a portion of the transport streams 240 to become output transport streams 242. The output signals 242 from the various modulators 228 or multimodulators are combined, using equipment such as a combiner 246, for input into the transmission medium 250, which is sent via the in-band delivery path 254 to subscriber locations (not shown). In-band delivery path 254 can include DTS 64, 68, 72, and ATS 60, as described with FIG. 1B. In one embodiment, the server 216 also provides various types of data 288 to the headend 11. The data, in part, is received by the media access control functions 224, that output MPEG transport packets containing data 266 instead of digital audio/video MPEG streams.

The control system 232 enables the television system operator to control and monitor the functions and performance of the STS 10. The control system 232 interfaces with various components, via communication link 270, in order to monitor and/or control a variety of functions, including the frequency spectrum lineup of the programming for the STS 10, billing for each subscriber, and conditional access for the content distributed to subscribers. Information, such as conditional access information, is communicated from the control system 232 to the multiplexing logic 222 where it is multiplexed into a transport stream 240. Among other things, the control system 232 provides input to the modulator 228 for setting the operating parameters, such as selecting certain media content instances or portions of transport streams for inclusion in one or more output transport stream 242, system specific MPEG table packet organization, and/or conditional access information. Control information and other data can be communicated to hubs 12 and DHCTs 16 via an in-band delivery path 254 or via an out-of-band delivery path 256.

The out-of-band data is transmitted via the out-of-band FDS 76 (FIG. 1B) of transmission medium 250 by means such as, but not limited to, a Quadrature Phase-Shift Keying (QPSK) modem array 226. Two-way communication utilizes the RDS 80 (FIG. 1B) of the out-of-band delivery path 256. Hubs 12 and DHCTs 16 transmit out-of-band data through the transmission medium 250, and the out-of-band data is received in headend 11 via out-of-band RDS 80. The out-of-band data is routed through router 264 to an application server 216 or to control system 232. The out-of-band control information includes such information as a pay-per-view purchase instruction and a pause viewing command from the subscriber location to a video-on-demand type application server located internally or external to the headend 11, such as application server 216, as well as any other data sent from the DHCT 16 (FIG. 1A) or hubs 12, all of which will preferably be properly timed. The control system 232 also monitors, controls, and coordinates all communications in the subscriber television system, including video, audio, and data. The control system 232 can be located at the headend 11 or remotely.

The transmission medium 250 distributes signals from the headend 11 to the other elements in the subscriber television system, such as a hub 12, a node 13, and subscriber locations (FIG. 1A). The transmission medium 250 can incorporate one or more of a variety of media, such as optical fiber, coaxial cable, and HFC, satellite, direct broadcast, or other transmission media.

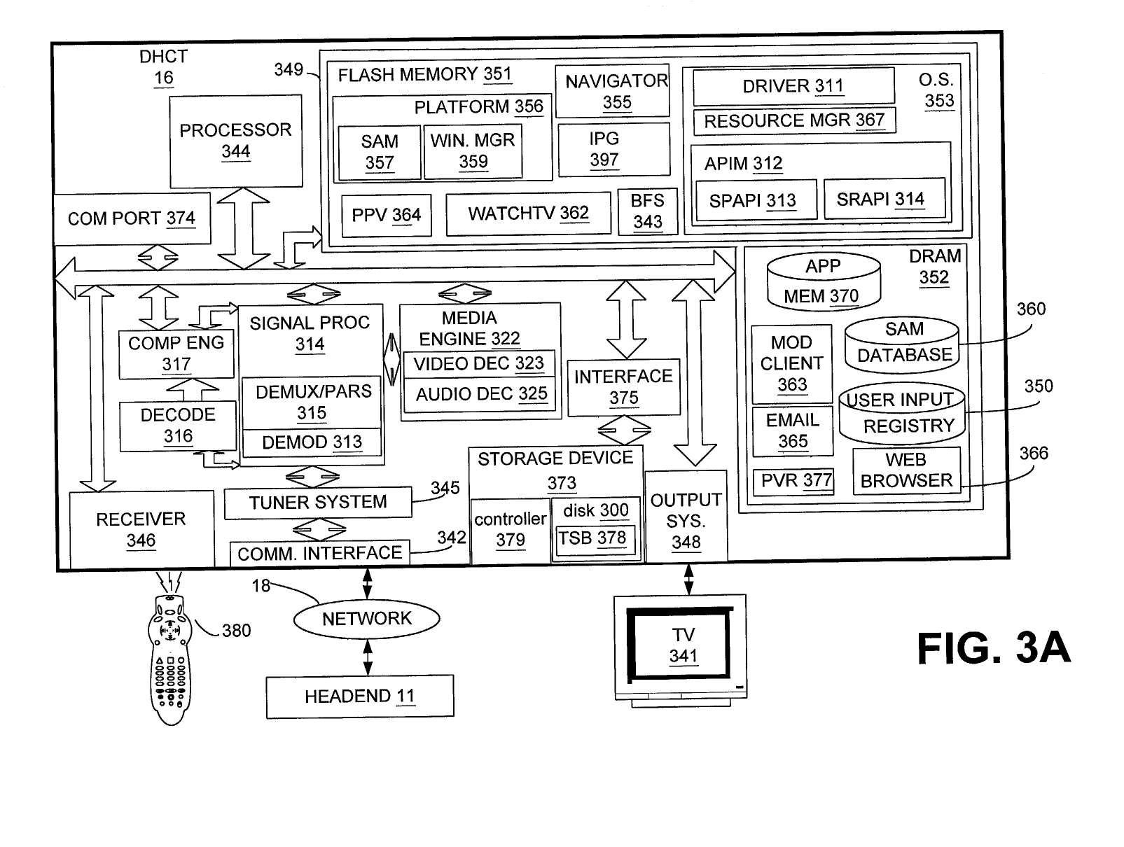

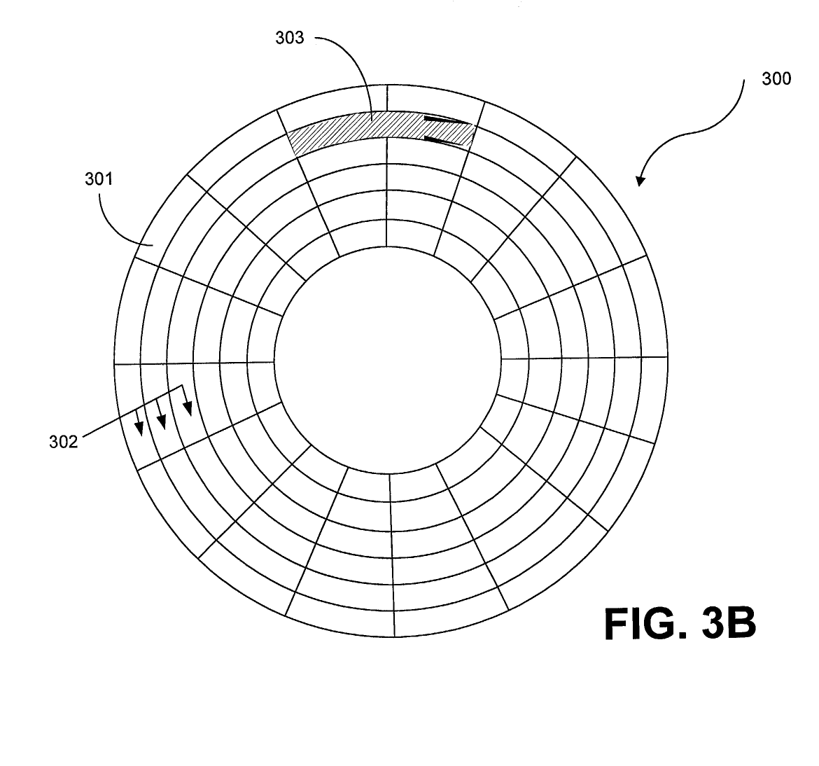

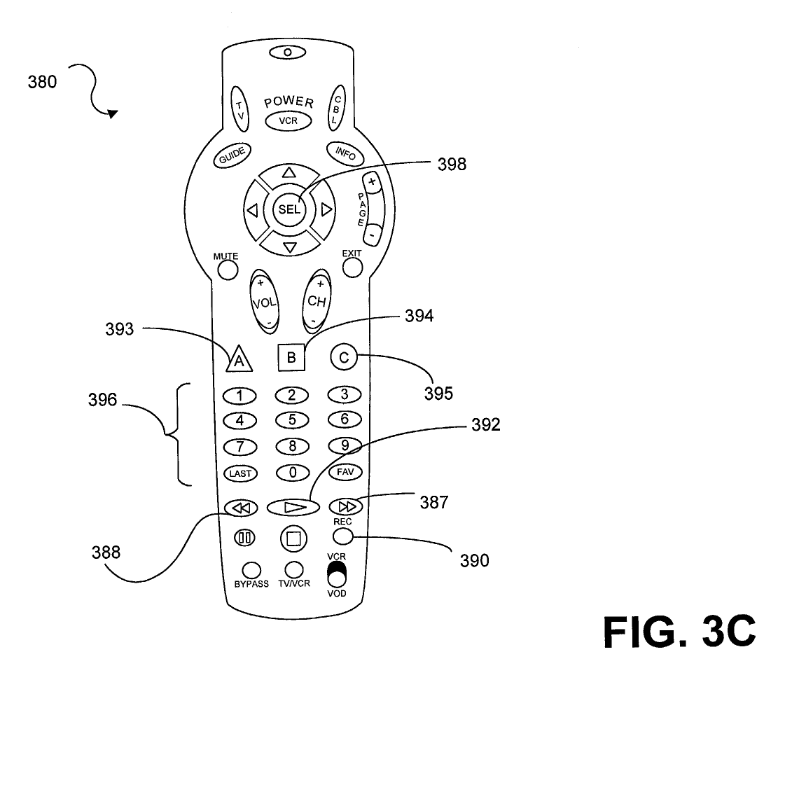

FIG. 3A is a block diagram illustration of a DHCT 16 that is coupled to a headend 11 and to a television, in accordance with one embodiment. It will be understood that the DHCT 16 shown in FIG. 3A is merely illustrative and should not be construed as implying any limitations upon the scope of the preferred embodiments of the invention. Some of the functionality performed by applications executed in the DHCT 16 (such as the MOD application client 363) may instead be performed at the headend 11 and vice versa. A DHCT 16 is typically situated at a user's residence or place of business and may be a stand alone unit or integrated into another device such as, for example, a television set or a personal computer or other display devices or an audio device. The DHCT 16 preferably includes a communications interface 342 for receiving signals (video, audio and/or other data) from the headend 11 through the network 18 and for providing any reverse information to the headend 11 through the network 18.

The DHCT 16 further includes one or more processors, such as processor 344, for controlling operations of the DHCT 16, an output system 348 for driving the television display 341, and a tuner system 345 for tuning into a particular television channel or frequency for content to be displayed and for sending and receiving various types of media content from the headend 11. The DHCT 16 may include, in other embodiments, multiple tuners for receiving downloaded (or transmitted) media content. Tuner system 345 can select from a plurality of transmission signals (FIG. 1B) provided by the subscriber television system. Tuner system 345 enables the DHCT 16 to tune to downstream media content and data transmissions, thereby allowing a user to receive digital or analog media content delivered in the downstream transmission via the subscriber television system. The tuner system 345 includes, in one implementation, an out-of-band tuner for bi-directional quadrature phase shift keying (QPSK) data communication and a quadrature amplitude modulation (QAM) tuner (in band) for receiving television signals. Additionally, a receiver 346 receives externally-generated information, such as user inputs or commands from an input device or other devices.

According to another embodiment of the invention, a telephone modem (not shown) in the DHCT 16 can be utilized for upstream data transmission and a headend 11, hub 12 (FIG. 1A) or other component located upstream in the STS 10 (FIG. 1A) can receive data from a telephone network corresponding with the telephone modem and can route the upstream data to a destination internal or external to the STS 10, such as an application data server in the headend 11 or content provider.

The DHCT 16 includes at least one storage device 373 to provide storage for downloaded media content. PVR application 377 (described in greater detail below), in cooperation with the operating system 353 and the device driver 311 and the device controller 379, effects, among other functions, read and/or write operations to the storage device 373. Storage device 373 is preferably internal to DHCT 16, coupled to a common bus through a communication interface 375, preferably an integrated drive electronics (IDE) interface or small computer system interface (SCSI), although IEEE-1394 or USB, among others, can be used. Alternatively, the storage device 373 can be externally connected to (and thus removable from) the DHCT 16 via a communication port 374 implemented as IEEE-1394 or USB or via a data interface port such as a SCSI or an IDE interface.

Storage device 373 comprises storage for media content and/or data that can be written to for storage and later read from for retrieval for presentation. Storage device 373 can be an optical storage device or a magnetic storage device, among others, and is preferably a hard disk drive. The storage device 373 preferably includes at least one hard disk 300. Throughout this disclosure, references relating to writing to or reading from the storage device 373, or references regarding recordings from or to the storage device 373 will be understood to mean that such read or write operations are occurring from or to the actual medium (for example, the hard disk 300) of the storage device 373. Preferably, located in each hard disk 300 is one or more time shift buffers (TSBs) 378, which comprise a plurality of clusters (as described below) for temporarily receiving media content and/or data. The storage device 373 is also comprised of a controller 379 that receives operating instructions from the device driver 311 of the operating system 353 and implements those instructions to cause read and/or write operations to the hard disk 300. The device driver 311 communicates with the storage device controller 379 to format the hard disk 300, causing the hard disk to be divided radially into sectors 301 and concentric circles called tracks 302, as illustrated by the block diagram illustration of the example hard disk 300 in FIG. 3B. Note from FIG. 3B that the same number of sectors 301 per track 302 are illustrated, but other embodiments with a different number of tracks per side, sectors per track, bytes per sector, and in different zones of tracks, are within the scope of the preferred embodiments of the invention. The sector 301 is the basic unit of storage on the hard disk 300. In one implementation, each sector 301 of a hard disk 300 can store 512 bytes of user data. While data is stored in 512-byte sectors on the hard disk 300, the cluster, such as example cluster 303, is typically the minimum unit of data storage the operating system 353 uses to store information. Two or more sectors on a single track make up a cluster.

In one implementation, under the auspices of the real-time operating system 353 executed by processor 344, and in coordination with the PVR application client 377, downloaded media content is received in DHCT 16 via communications interface 342 and stored in a temporary cache (not shown) in memory 349. The temporary cache is implemented and managed to enable media content transfers from the temporary cache to storage device 373, or, in concert with the insertion of a newly arriving media content into the temporary cache. In one implementation, the fast access time and high data transfer rate characteristics of the storage device 373 enables media content to be read from the temporary cache in memory 349 and written to storage device 373 in a sufficiently fast manner. Orchestration of multiple simultaneous data transfer operations is effected so that while media content is being transferred from the cache in memory 349 to storage device 373, new media content is received and stored in the temporary cache of memory 349.

The DHCT 16 includes signal processing system 314, which comprises demodulating system 313 and transport demultiplexing and parsing system 315 (herein demultiplexing system) to process broadcast media content and/or data. One or more of the systems of signal processing system 314 can be implemented with software, a combination of software and hardware, or preferably in hardware. Demodulating system 313 comprises functionality for RF signal demodulation, either an analog transmission signal or a digital transmission signal. For instance, demodulating system 313 can demodulate a digital transmission signal in a carrier frequency that was modulated, among others, as a QAM-modulated signal. When tuned to a carrier frequency corresponding to an analog TV signal transmission, demultiplexing system 315 is bypassed and the demodulated analog TV signal that is output by demodulating system 313 is instead routed to analog video decoder 316. Analog video decoder 316 converts the analog video signal (i.e. the video portion of a media content instance that comprises a video portion and an audio portion) received at its input into a respective non-compressed digital representation comprising a sequence of digitized pictures and their respective digitized audio. Presented at the input to analog video decoder 316 is an analog video signal such as NTSC video comprising of audio and video. In one implementation, the video consists of a sequence of fields spaced apart at approximately one-sixtieth of a second. A pair of consecutive fields constitutes a picture. The odd field contains the odd-numbered lines of the picture and the even field contains the even-numbered lines of the picture. Analog video decoder 316 outputs the corresponding sequence of digitized pictures and respective digitized audio. Each picture is a two dimensional entity of picture elements and each picture element contains a respective set of values. A picture element value comprises luminance and chrominance information that are representative of brightness and color information at the spatial location of the picture element within the picture.

Digitized pictures and respective audio output by analog video decoder 316 are presented at the input of compression engine 317. Digitized pictures and respective audio output by analog video decoder 316 can also be presented to an input of media engine 322 via an interface (not shown) dedicated for non-compressed digitized analog video and audio, such as ITU-656, for display on TV 341. Compression engine 317 is coupled to localized memory 349, preferably DRAM 352, for input and processing of the input digitized pictures and their respective digitized audio. Alternatively, compression engine 317 can have its own integrated memory (not shown). Compression engine 317 processes the sequence of digitized pictures and digitized audio and converts them into a video compressed stream and an audio compressed stream, respectively. The compressed audio and video streams are produced in accordance with the syntax and semantics of a designated audio and video coding method, such as specified by the MPEG-2 audio and MPEG-2 video ISO standard, so that they can be interpreted by video decoder 323 and audio decoder 325 for decompression and reconstruction at a future time. Each compressed stream consists of a sequence of data packets containing a header and a payload. Each header contains a unique program identification, or PID, associated with the respective compressed stream.

Compression engine 317 multiplexes the audio and video compressed streams into a transport stream, such as an MPEG-2 transport stream, for output. Furthermore, compression engine 317 can preferably compress audio and video corresponding to more than one program in parallel (e.g., two tuned analog TV signals) and to multiplex the respective audio and video compressed streams into a single transport stream. Output of compressed streams and/or transport streams produced by compression engine 317 is input to signal processing system 314. Parsing capabilities 315 within signal processing 314 allow for interpretation of sequence and picture headers, for instance, annotating their locations within their respective compressed stream for future retrieval from storage device 373. A compressed analog media content instance (e.g., TV program episode or show) corresponding to a tuned analog transmission channel can be output as a transport stream by signal processing 314 and presented as input for storage in storage device 373 via interface 375 as will be described below. The packetized compressed streams can be also output by signal processing 314 and presented as input to media engine 322 for decompression by video decompression engine 323 and audio decompression engine 325 for its display on TV 341, as will be described below.

Demultiplexing system 315 can include MPEG-2 transport demultiplexing. When tuned to carrier frequencies carrying digital transmission signals, demultiplexing system 315 enables the separation of packets of data, corresponding to the compressed streams of information belonging to the desired media content instances, for further processing. Concurrently, demultiplexing system 315 precludes packets in the multiplexed transport stream that are irrelevant or not desired, such as packets of data corresponding to compressed streams of media content instances of other media content signal sources (e.g. other TV channels), from further processing.

Parsing capabilities of demultiplexing system 315 include reading and interpreting the received transport stream without disturbing its content, such as to interpret sequence and picture headers, for instance, to annotate their locations within their respective compressed stream for future retrieval from storage device 373. Thus, the components of signal processing system 314 are capable of QAM demodulation, forward error correction, and demultiplexing MPEG-2 transport streams, and parsing packetized elementary streams and elementary streams. A compressed media content instance corresponding to a tuned carrier frequency carrying a digital transmission signal can be output as a transport stream by signal processing 314 and presented as input for storage in storage device 373 via interface 375 as will be described below. The packetized compressed streams can be also output by signal processing 314 and presented as input to media engine 322 for decompression by video decompression engine 323 and audio decompression engine 325 as will be described below.

One having ordinary skill in the art will appreciate that signal processing system 314 will preferably include other components not shown, including memory, decryptors, samplers, digitizers (e.g. analog-to-digital converters), and multiplexers, among others. Further, other embodiments will be understood, by those having ordinary skill in the art, to be within the scope of the preferred embodiments of the present invention, including analog signals (e.g. NTSC) that bypass one or more elements of the signal processing system 314 and are forwarded directly to the output system 348. Further, outputs presented at corresponding next-stage inputs for the aforementioned signal processing flow may be connected via accessible memory 349 in which the outputting device stores the output data and the inputting device thereafter inputs the output data written to memory 349 by the respective outputting device. Outputting and inputting devices include analog video decoder 316, compression engine 317, media engine 322, signal processing system 314, and components or subcomponents thereof. Further, it will be understood by those having ordinary skill in the art that components of signal processing system 314 can be spatially located in different areas of the DHCT 16. Further, it will be understood by those having ordinary skill in the art that, although the components of signal processing system 314 are illustrated as being in communication with an incoming signal from the communications interface 342, the signal may not necessarily be in the order shown for all signals.

The DHCT 16 also includes media engine 322, which includes digital video decoder 323 also known as video decompression engine, and digital audio decoder 325 also known as audio decompression engine, and other digital signal processing components not shown, as would be appreciated by those having ordinary skill in the art. For example, demultiplexing system 315 is in communication with tuner system 345, and processor 344 to effect reception of digital compressed video streams, digital compressed audio streams, and data streams corresponding to one or more media content instances to be separated from other media content instances and/or streams transported in the tuned transmission channel and to be stored in a first part (not shown) of DRAM 352 of DHCT 16 assigned to receive packets of one or more media content instances. Other dedicated memory may also be used for media content instance packets.

Furthermore, while conducting this process, demultiplexing system 315 demultiplexes and separates desired compressed streams from the received transport stream without disturbing its content. Further, parser 315 parses (i.e., reads and interprets) compressed streams such as to interpret sequence headers and picture headers, and deposits a transport stream carrying compressed streams of a media content instance into DRAM 352. Processor 344 causes transport stream in DRAM 352 to be transferred to the storage device 373 via interface 375. Under program control by processor 344, the demultiplexing system 315 in communication with the digital video decoder 323, storage device 373, and processor 344 effect notification and/or transfer of received packets of one or more compressed streams corresponding to one or more media content instances from a first part of DRAM 352 to a second part (not shown) of DRAM 352 assigned to the digital video decoder 323 and the digital audio decoder 325. Alternatively, media engine 322 can have access to a dedicated localized DRAM (not shown). Upon demultiplexing and parsing the transport stream carrying one or more media content instances, signal processing system 314 outputs to DRAM 352 ancillary data in the form of a table or data structure (not shown) comprising the relative or absolute location of the beginning of certain pictures in the compressed media content instance for convenience in retrieval during future operations.

In another embodiment, according to a plurality of tuners, and respective number of demodulating systems 313, demultiplexing systems 315, and signal processing systems 314, a respective number of broadcast digital media content instances are received and routed to the hard disk 300 of storage device 373 simultaneously. Alternatively, a single demodulating system 313, a single demultiplexing system 315, and a single signal processing system 314, each with sufficient processing capabilities can serve to process more than one digital media content instance.

In another embodiment according to the aforementioned description, a first tuner of tuning system 345 receives an analog video signal corresponding to a first media content instance and a second tuner simultaneously receives a digital compressed stream corresponding to a second media content instance. First media content instance is processed as an analog video signal and second media content instance is processed as a digital compressed stream as described above.

In one implementation, compression engine 317 can output formatted MPEG-2 or MPEG-1 packetized elementary streams (PES) inside a transport stream, all compliant to the syntax and semantics of the ISO MPEG-2 standard. Alternatively, compression engine 317 can output other digital formats that are compliant to other standards. The digital compressed streams output by compression engine 317 corresponding to a first media content instance are deposited in local memory for compression engine 317 and routed to demultiplexing system 315. Demultiplexing system 315 parses (i.e., reads and interprets) the transport stream generated by compression engine 317 without disturbing its content, such as to interpret picture headers, and deposits the transport stream into DRAM 352. Processor 344 causes transport stream in DRAM 352 to be transferred to the storage device 373. While parsing the transport stream, demultiplexing system 315 outputs to memory 352 ancillary data in the form of a table or data structure (not shown) comprising the relative or absolute location of the beginning of certain pictures in the compressed media content stream for the first media content instance for convenience in retrieval during future operations. In this way, random access operations such as fast forward, rewind, and jumping to a location in the compressed media content instance can be attained.

In another embodiment, according to a plurality of tuners, a respective number of analog video decoders 316, and a respective number of compression engines 317, the aforementioned compression of analog video and audio is performed and routed to hard disk 300 of the storage device 373 simultaneously for a respective number of analog media content instances. Alternatively, a single compression engine with sufficient processing capabilities can serve to compress more than one analog media content instance.

Processor 344 in communication generally with device driver 311 and storage device controller 379 and demultiplexing system 315 effect retrieval of compressed video streams, compressed audio streams, and data streams corresponding to one or more media content instances from storage device 373. Retrieved streams are deposited in an output cache in storage device 373 and transferred to memory 352, and then processed for playback according to mechanisms that would be understood by those having ordinary skill in the art. In some embodiments, the media content instances are retrieved and routed from the hard disk 300 to the video and audio decoding system simultaneously, and then further processed for eventual presentation on a display device or other device.

The DHCT 16 may also include one or more wireless or wired interfaces, also called communication ports 374, for receiving and/or transmitting data to other devices. For instance, the DHCT 16 may feature USB (Universal Serial Bus), Ethernet (for connection to a computer), IEEE-1394 (for connection to media content devices in an entertainment center), serial, and/or parallel ports. The user inputs may be, for example, provided by an input device including a computer or transmitter with buttons or keys located either on the exterior of the terminal or by a hand-held remote control device or keyboard that includes user-actuated buttons. In other embodiments, user input can include voice-activation. FIG. 3C is a block diagram of an example remote control device 380 to provide input to the DHCT 16. Rewind 388 and fast-forward 387 buttons enable a user to access buffered media content instances in the TSB 378. Record button 390 enables the user to record any media content instance buffered into the TSB 378, or provides for scheduled recordings as well, as described below. Playback 392 enables the playback of a media content instance. Lettered symbol buttons “A” 393, “B” 394, and “C” 395 correspond to like symbols on a screen that represent application client functionality. Similarly, numbered symbol buttons 396 enable a user to enter channels or implement application client functionality corresponding to like symbols on a screen. Many alternative methods of providing user input may be used including a remote control device with different buttons and/or button layouts, a keyboard device, a voice activated device, etc. Further, a user interface may present screen symbols, or icons (e.g. a hand with pointing index finger) to correspond with the select button 398 to provide for infinite screen navigation and select functionality. Other embodiments can include a touch-sensitive screen. The embodiments of the invention described herein are not limited by the type of device used to provide user input.

Continuing with FIG. 3A, in one implementation, the DHCT 16 includes system memory 349, which includes FLASH memory 351 and dynamic random access memory (DRAM) 352, for storing various applications, modules and data for execution and use by the processor 344. Basic functionality of the DHCT 16 is provided by an operating system 353 that is primarily stored in FLASH memory 351. Among other elements, the operating system 353 includes at least one resource manager 367 that provides an interface to resources of the DHCT 16 such as, for example, computing resources. Also included within operating system 353 is one or more device drivers that provides operating instructions to an internal or external storage device, such as storage device 373, and peripheral devices not shown. For example, device driver 311 provides operating instructions to the storage device controller 379 of the storage device 373 to effect, among other functions, read and/or write operations to the hard disk of the storage device 373. Operating system 353 also includes Application Programming Interfaces module (APIM) 312. The APIM 312 includes a set of programming structures that enable application clients to interface with the operating system 353. The APIM 312 includes, among other API's, a start playback API (SPAPI) 313 and start record API (SRAPI) 314, as will be described below.

One or more programmed software applications, herein referred to as applications, or application clients, are executed by utilizing the computing resources in the DHCT 16. Further, some of the operating system functionality can, in some embodiments, be performed at the application client level. The application clients may be resident in FLASH memory 351 or downloaded (or uploaded) into DRAM 352. Applications stored in FLASH memory 351 or DRAM 352 are executed by processor 344 (e.g., a central processing unit or digital signal processor) under the auspices of the operating system 353. Data required as input by an application is stored in DRAM 352 or FLASH memory 351 and read by processor 344 as need be during the course of the application's execution. Input data may be data stored in DRAM 352 by a secondary application or other source, either internal or external to the DHCT 16, or possibly anticipated by the application and thus created with the application at the time it was generated as a software application, in which case it is stored in FLASH memory 351. Data generated by an application is stored in DRAM 352 by processor 344 during the course of the application's execution. DRAM 352 also includes application memory 370 that various applications may use for storing and/or retrieving data.

An application referred to as navigator 355 is also resident in FLASH memory 351 for providing a navigation framework for services provided by the DHCT 16. The navigator 355 registers for and in some cases reserves certain user inputs related to navigational keys such as channel increment/decrement, last channel, favorite channel, etc. The navigator 355 also provides users with television related menu options that correspond to DHCT functions such as, for example, blocking a channel or a group of channels from being displayed in a channel menu.

The FLASH memory 351 also contains a platform library 356. The platform library 356 is a collection of utilities useful to applications, such as a timer manager, a compression manager, a configuration manager, an HTML parser, a database manager, a widget toolkit, a string manager, and other utilities (not shown). These utilities are accessed by applications via Application Programming Interfaces (APIs) as necessary so that each application does not have to contain these utilities. Two components of the platform library 356 that are shown in FIG. 3A are a window manager 359 and a service application manager (SAM) client 357.

The window manager 359 provides a mechanism for implementing the sharing of the screen regions and user input. The window manager 359 on the DHCT 16 is responsible for, as directed by one or more applications, implementing the creation, display, and deal location of the limited DHCT 16 screen resources. It allows multiple applications to share the screen by assigning ownership of screen regions, or windows. The window manager 359 also maintains, among other things, a user input registry 350 in DRAM 352 so that when a user enters a key or a command via the remote control device 380 or another input device such as a keyboard or mouse, the user input registry 350 is accessed to determine which of various applications running on the DHCT 16 should receive data corresponding to the input key and in which order. As an application is executed, it registers a request to receive certain user input keys or commands. When the user presses a key corresponding to one of the commands on the remote control device 380, the command is received by the receiver 346 and relayed to the processor 344. The processor 344 dispatches the event to the operating system 353 where it is forwarded to the window manager 359 which ultimately accesses the user input registry 350 and routes data corresponding to the incoming command to the appropriate application.

The SAM client 357 is a client component of a client-server pair of components, with the server component being located on the headend 11, preferably in the control system 223 (FIG. 2). A SAM database 360 (i.e. structured data such as a database or data structure) in DRAM 352 includes a data structure of services and a data structure of channels that are created and updated by the headend 11. Herein, database will refer to a database, structured data or other data structures as is well known to those of ordinary skill in the art. Many services can be defined using the same application component, with different parameters. Examples of services include, without limitation and in accordance with one implementation, presenting television programs (available through a WatchTV application 362), pay-per-view events (available through a PPV application 364), digital music (not shown), media-on-demand (available through an MOD application 363), and an interactive program guide (IPG) 397. In general, the identification of a service includes the identification of an executable application that provides the service along with a set of application-dependent parameters that indicate to the application the service to be provided. As a non-limiting example, a service of presenting a television program could be executed by WatchTV application 362 with a set of parameters specifying the HBO to view HBO or with a separate set of parameters to view CNN. Each association of the application component (tune video) and one parameter component (HBO or CNN) represents a particular service that has a unique service I.D. The SAM client 357 also interfaces with the resource manager 367, as discussed below, to control resources of the DHCT 16.

Application clients can also be downloaded into DRAM 352 at the request of the SAM client 357, typically in response to a request by the user or in response to a message from the headend 11. In this example, DRAM 352 includes a media-on-demand application (MOD) 363, an e-mail application 365, PVR application 377, and a web application 366. It should be clear to one with ordinary skill in the art that these applications are not limiting and merely serve as examples for the present embodiments of the invention. Furthermore, one or more DRAM based applications may be resident, as an alternative embodiment, in FLASH memory 351. These applications, and others provided by the subscriber television system operator, are top-level software entities on the network for providing services to the user.

In one implementation, applications executing on the DHCT 16 work with the navigator 355 by abiding by several guidelines. First, an application utilizes the SAM client 357 for the provision, activation, and suspension of services. Second, an application shares DHCT 16 resources with other applications and abides by the resource management policies of the SAM client 357, the operating system 353, and the DHCT 16. Third, an application handles situations where resources are only available with navigator 355 intervention. Fourth, when an application loses service authorization while providing a service, the application suspends the service via the SAM (the navigator 355 will reactivate an individual service application when it later becomes authorized). Finally, an application client is designed to not have access to certain user input keys reserved by the navigator (i.e., power, channel +/−, volume +/−, etc.).

The MOD application client 363 provides the user with lists of available media content titles for each media content instance to choose from and with media content instances requested by the user. The MOD application client 363 provides media content instances to the user by engaging, preferably, in a direct two-way IP (Internet Protocol) connection with VOD content servers 222 (FIG. 2).

The web application client 366 provides news and information content provided to the user, in one implementation, in a hierarchical series of hyper text markup language (HTML) or extensible markup language (XML) based screens that are preferably based on application servers in the headend 11. In one implementation, navigation through the information in the screen can be via buttons on the remote control device 380 corresponding to like symbols on the screen. In another implementation, navigation through the information of each screen, from the viewpoint of the user, can be via “point and click” using an input device such as a mouse or the remote control device 380.

An executable program or algorithm corresponding to an operating system component, or to a client platform component, or to a application client, or to respective parts thereof, can reside in and execute out of DRAM 352 and/or FLASH memory 351. Likewise, data input into or output from any executable program can reside in DRAM 352 or FLASH memory 351. Furthermore, an executable program or algorithm corresponding to an operating system component, or to a client platform component, or to an application client, or to respective parts thereof, can reside in FLASH memory 351, or in a local storage device (such as storage device 373) connected to DHCT 16 and be transferred into DRAM 352 for execution. Likewise, data input for an executable program can reside in FLASH memory 351 or a storage device and be transferred into DRAM 352 for use by an executable program or algorithm. In addition, data output by an executable program can be written into DRAM 352 by an executable program or algorithm and be transferred into FLASH memory 351 or into a storage device.

The PVR application 377 provides for media content recording functionality by enabling the writing to, and if requested by a user, the permanent recording to the storage device 373. Media content can be downloaded from a remote device, such as, for example, a remote server located in the headend 11, or from a home communication network (for example, a networked home computer). In one embodiment, the PVR application 377 manages buffer space, or a time shift buffer (TSB) 378, of downloaded media content, or content (e.g. programs, web pages, etc.), for each in-band tuner. Media content stored in clusters of the TSB 378 will have a temporary residence. This receiving of media content into the TSB 378 for temporary residence will also be referred to as buffering. The media content stored in the TSB 378 will either be deleted (i.e. the clusters storing the media content will be configured as writeable for eventual write operations that overwrite the media content within those clusters) or retained (through election by the user) as a permanent recording. A permanent recording will be understood to mean media content that is stored for an extended period of time as decided by the user. Permanent recordings are stored in non-buffer clusters (i.e. not in clusters of the TSB 378) that are not used for the TSB 378 in instances when the user elects in advance to make a scheduled recording of a media content instance that has not yet been tuned to at the DHCT 16. A permanent recording can also be achieved by selecting a media content instance stored in the TSB 378 and designating the media content instance as permanent. In this latter implementation, the designated media content is stored in clusters that are configured from TSB clusters to permanent recording clusters (non-buffer space or non-buffer clusters), as described below. Thus, permanent recordings will preferably be more permanent than media content in the TSB 378, and permanent recordings can eventually be deleted from the disk space, typically at the explicit request of a user, as one example. Media content received from a remote server or other remote device is temporarily stored (i.e. buffered) in the TSB 378, unless the media content is, initially, permanently recorded (as described above).

Media content and other information can be received from independent media content sources, such as media content streams (for example broadcast analog video and transport streams) and pages of HTML or XML content, via the dual in-band tuners of the DHCT 16, or separately sourced from the in-band and out-of band signals for a single tuner DHCT 16. The PVR application 377 preferably provides for storage of media content, received from one media content source, to the storage device 373 while enabling the user to view information from another media content source. The PVR application 377 also receives program guide data, for example from an IPG application 397 (FIG. 3), that receives updated program information from the headend 11 and that provides start and end times (i.e. duration) of each media content instance. With this information, the PVR application 377 can keep track of the media content instances stored in the storage device 373. The PVR application 377 (FIG. 3A) maintains the complete guide data for the buffered and permanently recorded media content instances by either maintaining a pointer to a media content instance guide database (not shown) in the PVR application 377, or by copying the particular media content instance information from a media content instance guide database (such as an IPG database or a database maintained in application memory 370 (FIG. 3A)) to the database of the PVR application 377. Alternatively, the PVR application 377 may use the applications database 370 in lieu of providing its own database. Preferably, the PVR application 377 uses the storage device 373 for storing the media content instance guide data. The media content instance guide data provides a source for the PVR application 377 to display (to a user) a list of media content instances currently in the storage device 373 that have guide data available.

The PVR application 377 also provides for scheduled recordings outside of the TSB 378. Scheduled recordings can be implemented through an IPG Future Program Options menu (not shown). Another way to invoke scheduled recordings is to press RECORD on the remote control when a future media content instance is highlighted in an IPG (not shown). To implement permanent recordings (i.e. recordings made to non-buffer, or recorded, space), the PVR application 377 communicates to the device driver 311 that the indicated media content instance is to be written to the hard disk at the scheduled time. The device driver 311, in cooperation with the storage device controller 379, then allocates disk space for the scheduled recording and associates the location of that scheduled recording on the disk to a filename in a file allocation table (FAT) (not shown).

Write operations to the recorded space of the storage device medium or media can also occur automatically, while being transparent to a user, via a set of Application Programming Interfaces (APIs) such as a start record API (SRAPI) 314 and a start playback API (SPAPI) 313 (FIG. 3A), in accordance with one embodiment of the invention. The SRAPI 314 and SPAPI 313 are a set of controls for a third party application to invoke the services of the PVR application 377. Alternatively, functionality of the SRAPI 314 and the SPAPI 313 can be implemented remotely, such as in a remote server at the headend 11 (FIG. 2), as one example. The SRAPI 314 can be used to initiate recording of the originally viewed content, via the PVR application 377, to the storage device 373 automatically when the user elects to “jump” from the originally viewed content (herein first content) to view a second content. Alternatively, with sufficient memory, permanent recordings can be made to system memory 349 and “returns” can be made to the location of the content in system memory 349. The second content can be sourced from the first media content stream (i.e. the source of the first content), or a different media content stream, or the second content can be page(s) of HTML or XML content, among others. The SPAPI 313 provides, in one embodiment, for the automatic playback of the missed first content, recorded in the storage device 373, when the user exits the second content. Thus, the SPAPI 313 enables the user to begin viewing from a location in the first content from where the user exited to view the second content. Alternatively, the user can go to a third content (then fourth, fifth, etc.) from the second content before returning to the first content. Alternatively, the user can be presented with another screen (described below) after viewing the first content that enables the user to select whether he or she wants to return where he or she left off in the first content, or skip the recorded content to the real-time or live point of currently tuned media content, or go to a third content.

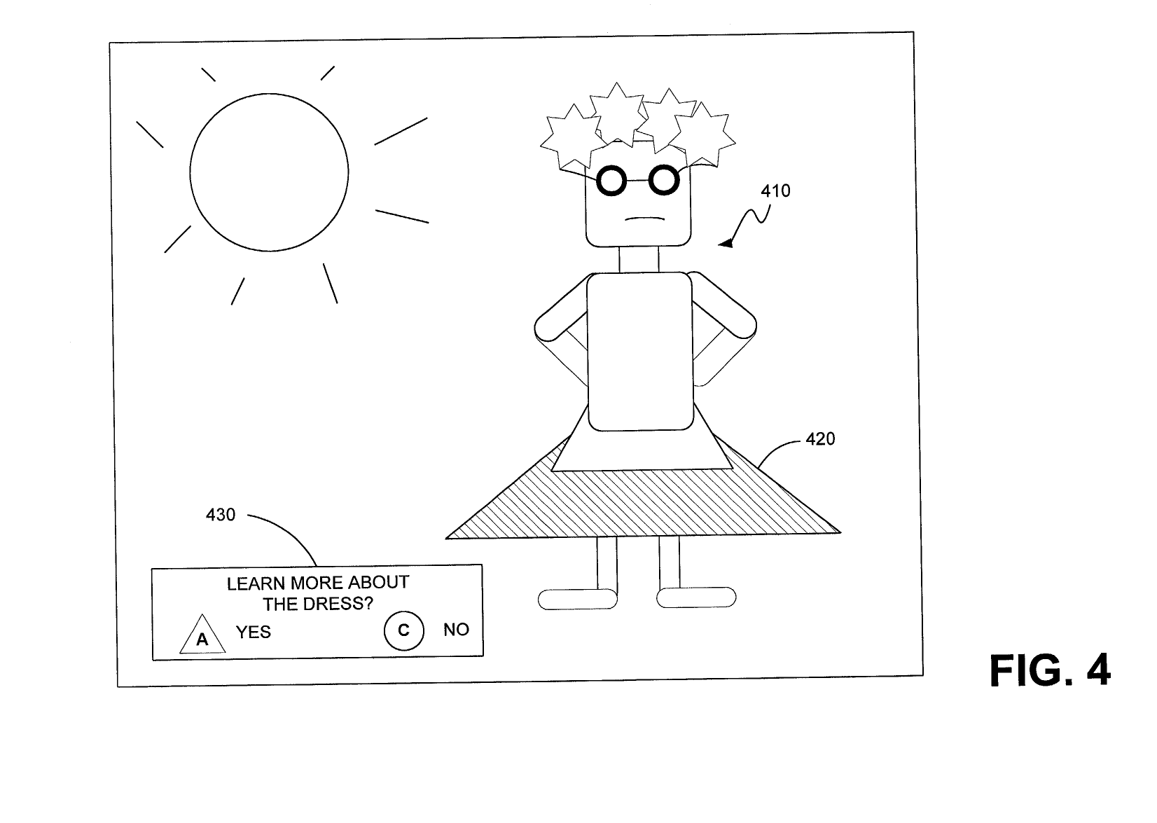

FIG. 4 is an example screen display that represents first content a user may be viewing on a television screen. The first content illustrated is a movie (i.e. media content instance) from an analog or digital broadcast, but could be media content provisioned for by any application client, concerning any subject matter, such as shopping on a home shopping network or viewing a site (e.g. web-page) on the Internet. In this example, the user is watching a broadcast movie, provisioned for by the WatchTV application 362 (FIG. 3A), where the heroine 410 is wearing a fancy dress 420. At any time, a prompt, or “bug” 430, can be presented on the screen display asking the viewer if he or she is interested in buying this dress (or a similar dress). The “bug” 430 is a graphic overlay that is prompted by auxiliary data in the media content stream that is received at the DHCT 16 (FIG. 3A) from the headend 11 (FIG. 2). The operating system 353 (FIG. 3A) detects the auxiliary data and causes an event. The event is a set of operations that will involve various DHCT resources in response to the auxiliary data. Applications, upon initialization, have registered for various events that will take place in the DHCT 16. When the event is generated, a secondary application (or applications) that has registered for the event will be activated by the operating system 353. The auxiliary data can be inserted in the vertical blanking interval (VBI) of an analog media content stream, or inserted in one of the elementary streams of a transport stream downloaded and identified by the program identification (PID) associated with the media content instance of interest, as is well known to those of ordinary skill in the art, among others. This auxiliary data can be inserted by the content provider and/or system operator, either manually, automatically, or integrated as part of a purchased package. The auxiliary data can comprise brief information content and a service ID for broadcast media content or otherwise a Universal Resource Locator (URL). The operating system 353 uses the service ID or URL to generate the event, as well as to provide a location to enable the secondary application to retrieve the second content. Thus, if the second content was a web-page, or a filename corresponding to content stored locally (e.g. at the DHCT 16), the secondary application can use the URL to locate the web-page or the file of interest. If the second content was part of the initial content stream or another content stream, the secondary application can use the service ID to invoke the services of the secondary application. In other embodiments, the URL can also be used for broadcast content.

The secondary application client displays the “bug” 430, the “bug” comprising information content based on the auxiliary data, to prompt the user to respond. The secondary application then “looks” for the key press event corresponding to the user response prompted by the “bug”. The “bug” can be a selectable feature for the user, such that the user can elect through a service menu screen (not shown) to have the “bug” prompted or not. The “bug” 430 can be presented on the display for a brief period, after which it times out and disappears if the user does not select the remote button as suggested by the screen “bug” 430. Alternatively, the user can be presented with the “bug” 430 until the user takes action by inputting a response.

Continuing the example, if the user decides to buy the dress 420, he or she presses, in this example, the “A” button 393 on the remote control device 380 (FIG. 3C) as suggested by the “bug” 430 for affirmative responses. This keypress event, in one implementation, causes two substantially concurrent events. First, the secondary application (in this example, the web application client 366) (FIG. 3A) uses the URL identified in the auxiliary data to identify where the information corresponding to the “bug” 430 can be located. Alternatively, the operating system 353 (FIG. 3A) can evoke the SAM application client 357 (FIG. 3A) to provision a secondary application identified by the service ID or URL in the auxiliary data. Alternatively, the controlling application (i.e. the application providing the first content) can activate the secondary application, based on the URL or service ID provided in the auxiliary data.

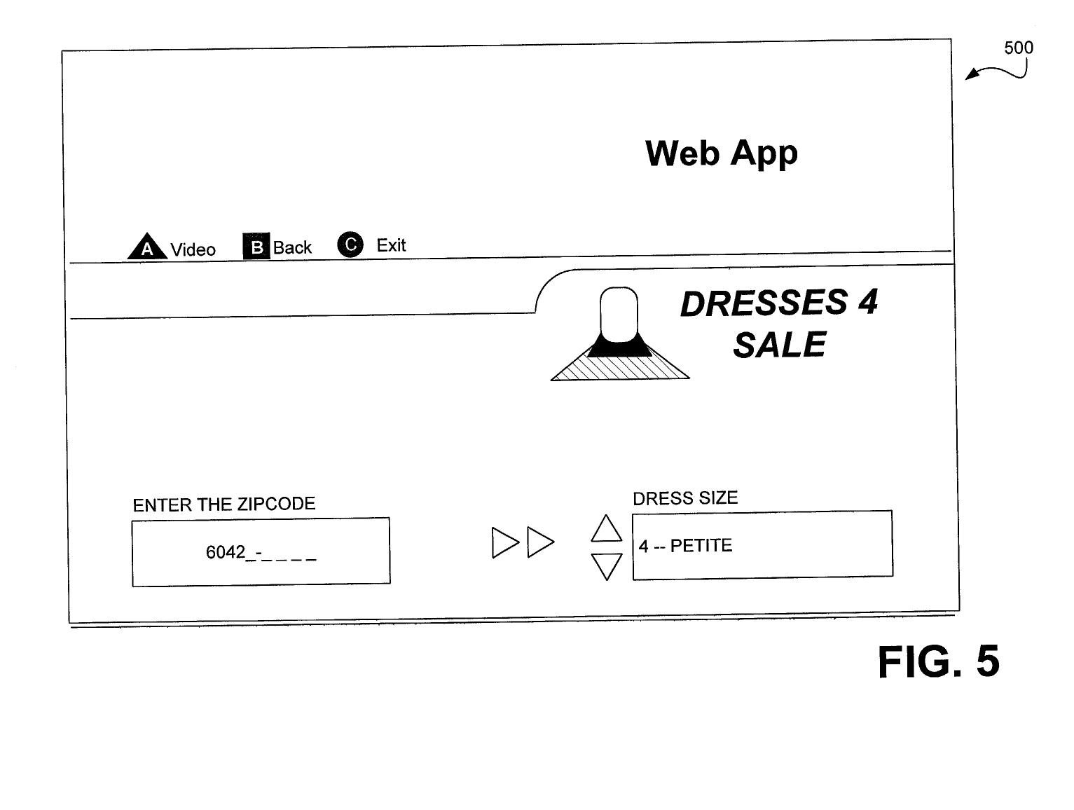

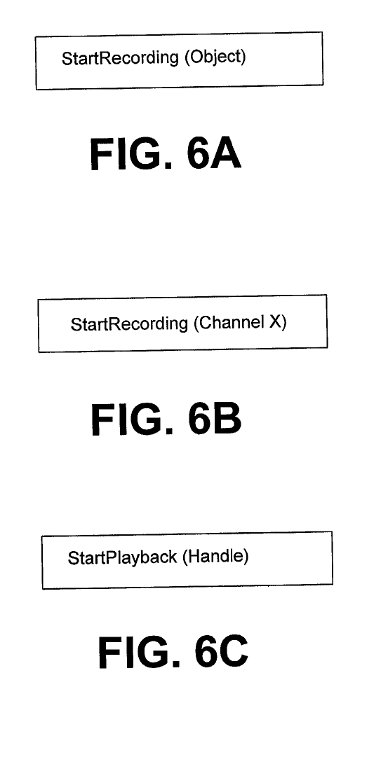

Continuing with the example, the location (identified by the URL) is an HTML page, displayed on the screen, for the makers of the dress, as shown in FIG. 5. In this example, although the second content is HTML content, the second content can be XML, or some other content formatted as Internet protocol (IP) and downloaded via the QPSK or DOCSIS out of band signal described in association with FIG. 2. In other embodiments, the second content can be an elemental stream that is part of the first content. In other embodiments, the second content can be a second media content instance received off a second in-band tuner (not shown) in the DHCT 16 (FIG. 3A). The screen 500 (or web page) provides a user with a choice of options for purchasing location and manner of payment for the dress 420 (FIG. 4) that the heroine was wearing. The other event caused by the keypress event with the remote control device 380 (FIG. 3C) is the evocation of the SRAPI 314 (FIG. 3A). In one embodiment, the SRAPI 314 evokes the PVR application client functionality resulting in the substantially immediate recording of the movie to the permanent, or non-buffer, space of the hard disk 300 (FIG. 3B) of the storage device 373 (FIG. 3A). The SRAPI 314, in one of many different embodiments, can be formatted in an object oriented structure that causes the PVR application 377 (FIG. 3A) to start recording the object (i.e. the first content) from where the user launched to the web site to permanent recorded space in the storage device 373, as illustrated in FIG. 6A. In another embodiment, the SRAPI 314 may be formatted to cause the PVR application to start recording “the channel X”, as illustrated in FIG. 6B. For the SRAPI 314 denoted by the example “C” programming structure depicted in FIG. 6B, “X” can be another channel (i.e. an analog broadcast channel or a digital transmission signal at a specified carrier frequency) that is presenting, or will be presenting, media content that the user had previously indicated a desire to see or hear based on a previously implemented preference filter. By evoking the SRAPI 314, the first content from which the user launched to the web site begins to automatically be written to recorded space of the storage device 373. The PVR application 377 causes the device driver 311 (FIG. 3A) to write the first content to non-buffer space in the storage device 373. The operating system 353 (FIG. 3A) returns a handle, or reference, and the device driver 311 returns a real-time clock value or a pointer to the SPAPI 313 indicating the location of the start of the non-buffer space to which the first content is being recorded while the user is viewing the second content.

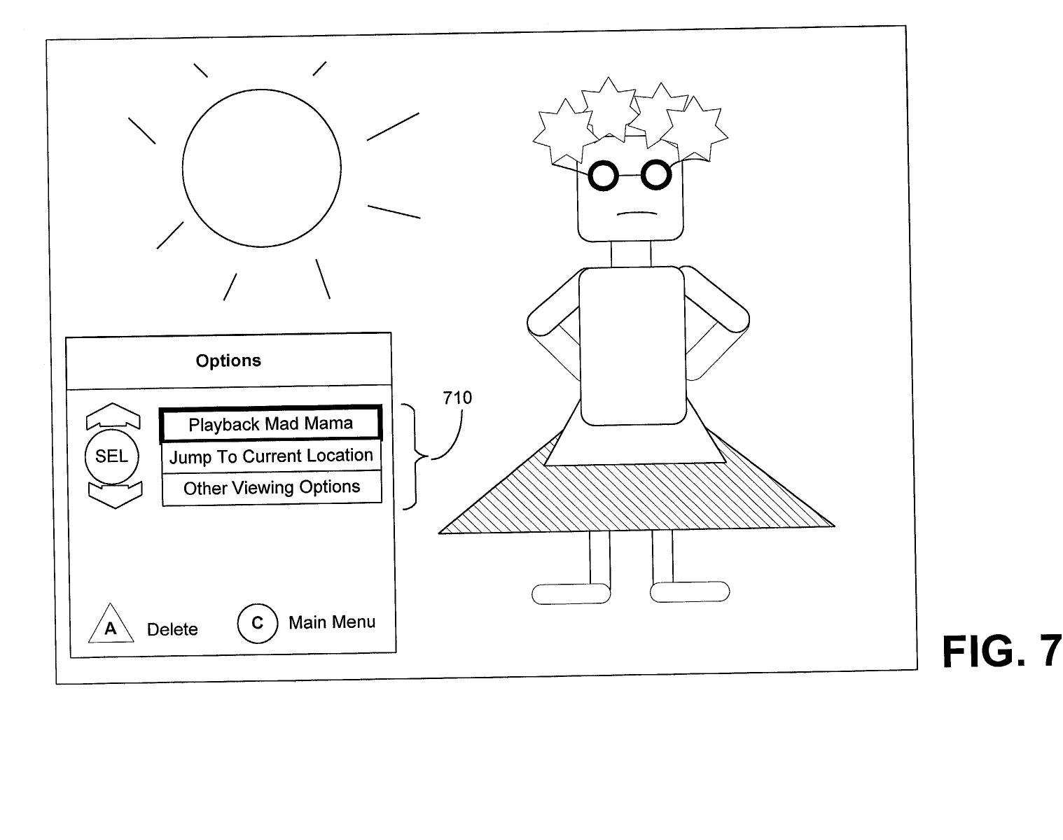

The second content can provide further links for the user to navigate to additional content (e.g. a third content, fourth content, etc.) while the SRAPI 314 (FIGS. 6A,B) continues to cause the missed first content, and additional content in the same stream if the first content instance has ended, to be written to the storage device 373 (FIG. 3A). If there are no other links, the user simply exits (e.g. using a displayed exit button corresponding to a button on the remote control device 380 (FIG. 3C), or positioning a cursor over an appropriate symbol on the screen display) from the second content and, in one implementation, is automatically returned to the location in the first content from which the user exited. When the user exits the second content, another API, the SPAPI 313, is evoked by the secondary application. An example “C” programming structure for the SPAPI 313 is illustrated in FIG. 6C. Provisioned with the handle and clock or pointer received from the operating system 353 and the device driver 311 (FIG. 3A), the SPAPI 313 automatically causes playback from the location in the first content where the user “jumped” to the second content. Thus, playback is from the recorded space of the storage device 373 (i.e. medium of the storage device 373 (FIG. 3A)). In another implementation, the SPAPI 313 can be augmented with an additional arguments (not shown) to cause the PVR application 377 (FIG. 3A) to display a GUI with selectable playback options. The display can be overlayed on the video frame of the beginning of the missed first content, or provided as a separate screen, among other embodiments. An example display screen with the GUI is illustrated in FIG. 7. As shown, the user, upon exiting the first content, can be presented several options from an options menu 710. One option includes watching the first content (and any additional content saved to the hard disk 300 while the user was viewing the second or additional content) from where the user initially exited. Another option includes skipping the recorded first content and jumping forward to the real-time, currently tuned, media content. Finally, another option can include going to a third content (e.g. other options). If the user elects to bypass the recorded (missed) first content, control transfers to the controlling application (in this example, Watch TV application 362, FIG. 3A) causing the download of the content actively being tuned to. If the user elects to jump to a third content, the first content continues to be recorded to the non-buffer space until the user decides to return to the first content or resume viewing at the currently tuned media content.

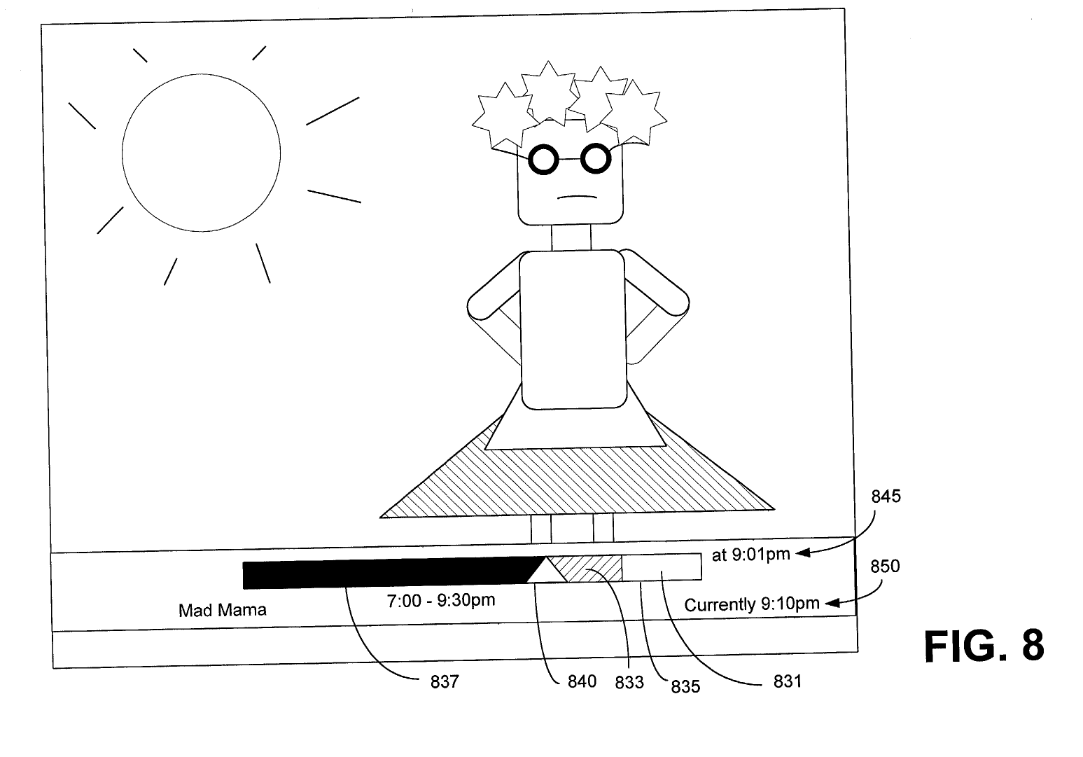

When the user returns to the missed, or recorded first content, the user can be presented with visual (or audio) feedback to indicate to the user where they are, in time, in the permanent recording relative to the active recording position to the recorded space. In one implementation, as illustrated in FIG. 8, the user can be presented with a progress bar 835 that indicates where in the content, relative to the active recording position, the playback position is located. As noted, the progress bar 835 includes an indicator 840 of where in the program (i.e. the first content), Mad Mama, the user is currently. This playback position corresponds in time to the record time clock reference 845. There are three portions within the progress bar, in this example, corresponding to content not recorded (i.e. before the user jumped to the second content) 837, content recorded 833, and time left for viewing or recording Mad Mama 831. The live point (i.e. where in the first content the tuner is currently tuned) is indicated by the live clock reference 850. The live point also is indicated by the boundary between the portions 833 and 831. This progress bar 835 can be presented initially to the user upon return from the second content (and after the options menu of FIG. 7, in some implementations) wherein an internal clock in the DHCT 16 can cause the progress bar 835 to time out (i.e. disappear) from the screen display. Alternatively, the user may cause the progress bar to disappear by pressing a button on the remote control device 380. These user interfaces for the screen displays are generated by the PVR application 377, based partly on the program information for all media content stored in the PVR application 377, application memory 370, or the storage device 373, as explained above. The progress bar 835 can be equipped with additional visual aids, for example a right-pointing arrow (not shown) at the right hand side of the progress bar 835, suggesting to a user that additional content (e.g. a third content) was recorded while the user was viewing the second or additional content. In an alternate embodiment, the user can be presented with a set of digital or analog clock displays in an unobtrusive position on the screen display (not shown) that indicates the current record position relative to the playback position. Should the user decide he or she does not want to watch the recorded first content he or she missed when launching to the second content, the user can invoke a permanent recording table (not shown) that offers the user the option to delete or defer viewing of the missed recorded first content.

In an alternative embodiment, an API can be evoked that causes the PVR application client 377 (FIG. 3A) to continue buffering the first content to the TSB 378 instead of recording to the recorded (non-buffer) space of the storage device 373. In this alternate embodiment, the user launches to the second content without invoking a start recording API (i.e. SRAPI 314). Instead, the PVR application 377 “marks” (i.e. provides a handle and clock or pointer value) indicating where the user was when the user launched to the linked site (i.e. second content) and stores that value in a data structure (not shown) associated with the PVR application 377. Upon return, a playback API takes the launch marker as a reference and returns the user to that marker location in the TSB 378. A progress bar, similar to the one used in FIG. 8, can be used to indicate to the user the current playback location relative to the active playback location in the TSB 378.

In an alternative embodiment, the user may not be presented with a “bug”, but instead, there may be second content associated with the first content. For example, a commentator for the first media content instance, such as a sportscaster for the ESPN show, may indicate to the viewer (or relayed to the viewer as text on the screen display) that additional statistical data is available at a designated web page. The URL of the web-page may be permanently associated with the first media content instance, or the media content stream or frequency providing the media content instance, thus enabling the user to choose at any moment to switch to the second content via a key-press of the remote control device 380 (FIG. 3C). As before, the SRAPI 314 will be evoked to begin saving the first content to the hard disk 300 (FIG. 3B). Also, when the user exits the second content (in this example, a web-page), the user can be presented with options on a GUI, in one implementation, or automatically returned to the beginning of the recorded first content without a GUI in another implementation.

The SRAPI 314 and SPAPI 313 and other supporting functionality described herein can be implemented in hardware, software, firmware, or a combination thereof. In the preferred embodiment(s), the SRAPI 314 and SPAPI 313 and other supporting functionality described herein are implemented in software or firmware that is stored in a memory and that is executed by a suitable instruction execution system. If implemented in hardware, as in an alternative embodiment, the SRAPI 314 and SPAPI 313 and other supporting functionality described herein may be implemented with any or a combination of the following technologies, which are all well known in the art: a discrete logic circuit(s) having logic gates for implementing logic functions upon data signals, an application specific integrated circuit (ASIC) having appropriate combinational logic gates, a programmable gate array(s) (PGA), a field programmable gate array (FPGA), etc.

The SRAPI 314 and SPAPI 313 and other supporting functionality described herein, which comprises an ordered listing of executable instructions for implementing logical functions, can be embodied in any computer-readable medium for use by or in connection with an instruction execution system, apparatus, or device, such as a computer-based system, processor-containing system, or other system that can fetch the instructions from the instruction execution system, apparatus, or device and execute the instructions. In the context of this document, a “computer-readable medium” can be any means that can contain, store, communicate, propagate, or transport the program for use by or in connection with the instruction execution system, apparatus, or device. The computer readable medium can be, for example but not limited to, an electronic, magnetic, optical, electromagnetic, infrared, or semiconductor system, apparatus, device, or propagation medium. More specific examples (a nonexhaustive list) of the computer-readable medium would include the following: an electrical connection (electronic) having one or more wires, a portable computer diskette (magnetic), a random access memory (RAM) (electronic), a read-only memory (ROM) (electronic), an erasable programmable read-only memory (EPROM or Flash memory) (electronic), an optical fiber (optical), and a portable compact disc read-only memory (CDROM) (optical). Note that the computer-readable medium could even be paper or another suitable medium upon which the program is printed, as the program can be electronically captured, via for instance optical scanning of the paper or other medium, then compiled, interpreted or otherwise processed in a suitable manner if necessary, and then stored in a computer memory.

It should be emphasized that the above-described embodiments of the invention, particularly, any “preferred embodiments” are merely possible examples of implementations, merely setting forth a clear understanding of the principles of the inventions. Many variations and modifications may be made to the above-described embodiments of the invention without departing substantially from the spirit of the principles of the invention. All such modifications and variations are intended to be included herein within the scope of the disclosure and invention and protected by the following claims.

Therefore, having thus described the invention, at least the following is claimed:

1. An interactive media method, comprising the steps of:
receiving first media content;
transitioning from the first media content to second media content; and
recording the first media content responsive to transitioning to the second media content.

2. The method of claim 1, further comprising the step of receiving auxiliary data, from a remote server, that provides notice of the second media content and provides the location of the second media content.

3. The method of claim 2, wherein the auxiliary data includes a universal resource locator.

4. The method of claim 2, wherein the auxiliary data includes a service ID.

5. The method of claim 1, further comprising the step of automatically returning to the beginning of the recorded first media content.

6. The method of claim 5, wherein the recorded first media content is located on a medium in a storage device.

7. The method of claim 5, further comprising the step of automatically playing back the recorded first media content.

8. The method of claim 1, further comprising the step of providing a user interface, after exiting the second media content, that presents viewing options.

9. The method of claim 8, wherein the viewing options includes playing back from the beginning of the recorded first media content, returning to the real-time location of currently tuned media content, and transitioning to third media content.

10. The method of claim 1, wherein the step of recording the first media content further comprises the step of buffering the first media content to a medium in a storage device.

11. The method of claim 1, wherein the step of recording the first media content further comprises the step of recording the first media content to non-buffer space on a medium in a storage device.

12. The method of claim 1, further comprising the step of receiving the first media content and the second media content from a remote server.

13. The method of claim 1, further comprising the step of receiving the first media content and the second media content from a local computer.

14. The method of claim 1, further comprising the step of providing a user interface for providing notice to the user of the second media content and providing the option of receiving the second media content and not receiving the second media content.

15. The method of claim 14, wherein the displayed notice can be enabled and disabled by the user.

16. The method of claim 1, further comprising the step of storing a storage medium location of the first media content, where the transition to the second media content began, in memory.

17. The method of claim 16, wherein the location is a handle and a real-time clock value.

18. The method of claim 16, wherein the location is a handle and a pointer value.

19. The method of claim 1, further comprising the step of storing a memory address of the first media content, where the transition to the second media content began, in memory.

20. The method of claim 1, further comprising the step of transitioning from the second media content to third media content.

21. The method of claim 1, wherein the first media content is broadcast media content.

22. The method of claim 1, wherein the first media content is web-content.

23. The method of claim 1, wherein the second media content is broadcast media content.

24. The method of claim 1, wherein the second media content is web-content.

25. The method of claim 1, wherein the step of transitioning further includes the step of receiving user commands to transition.

26. The method of claim 1, wherein the step of transitioning further includes the step of receiving instructions associated with the first media content that the second media content is available at a specified location.

27. The method of claim 26, wherein the instructions are verbal instructions from a commentator presenting in the first media content.

28. The method of claim 26, wherein the instructions are symbol instructions displayed in the display of the first media content.

29. The method of claim 26, wherein the specified location is a web address.

30. The method of claim 26, wherein the specified location is a media content stream.

31. The method of claim 1, further comprising the step of providing a user interface on a screen display that indicates where in playing back the recorded first media content the user is relative to the real-time currently tuned location.

32. The method of claim 1, further comprising the step of displaying the second media content while recording the first media content.

33. An interactive media method, comprising the steps of:
receiving first media content;
receiving auxiliary data that provides notice of second media content and the location of the second media content while receiving the first media content;
providing a user interface, in response to the auxiliary data, that alerts a user to the existence of the second media content and provides a selectable option to transition to the second media content;
transitioning from the first media content to the second media content in response to the user selecting to transition to the second media content;
recording the first media content, to a medium on a storage device, responsive to transitioning to the second media content;
storing the medium location of the first media content in memory;
displaying the second media content while recording the first media content; and
automatically returning to the beginning of the recorded first media content.

34. An interactive media system, comprising:
a memory with logic; and
a processor configured with the logic to receive first media content, wherein the processor is further configured with the logic to receive auxiliary data that provides notice of second media content and the location of the second media content while receiving the first media content, wherein the processor is further configured with the logic to provide a user interface, in response to the auxiliary data, that alerts a user to the existence of the second media content and provides a selectable option to transition to the second media content, wherein the processor is further configured with the logic to transition from the first media content to the second media content in response to the user selecting to transition to the second media content, wherein the processor is further configured with the logic to record the first media content, to a medium on a storage device, responsive to transitioning to the second media content, wherein the processor is further configured with the logic to store the medium location of the first media content in memory, wherein the processor is further configured with the logic to display the second media content while recording the first media content, wherein the processor is further configured with the logic to automatically return to the beginning of the recorded first media content.

35. An interactive media system, comprising:
a memory with logic; and
a processor configured with the logic to receive first media content, wherein the processor is further configured with the logic to transition from the first media content to second media content, wherein the processor is further configured with the logic to record the first media content responsive to transitioning to the second media content.

36. The system of claim 35, wherein the processor is further configured with the logic to receive auxiliary data, from a remote server, that provides notice of the second media content and provides the location of the second media content.

37. The system of claim 36, wherein the auxiliary data includes a universal resource locator.

38. The system of claim 36, wherein the auxiliary data includes a service ID.

39. The system of claim 35, wherein the processor is further configured with the logic to automatically return to the beginning of the recorded first media content.

40. The system of claim 39, wherein the recorded first media content is located on a medium in a storage device.

41. The system of claim 39, wherein the processor is further configured with the logic to effect automatically playing back the recorded first media content.

42. The system of claim 35, wherein the processor is further configured with the logic to provide a user interface, after exiting the second media content, that presents viewing options.

43. The system of claim 42, wherein the viewing options includes playing back from the beginning of the recorded first media content, returning to the real-time location of currently tuned media content, and transitioning to third media content.

44. The system of claim 35, wherein the processor is further configured with the logic to buffer the first media content to a medium in a storage device.

45. The system of claim 35, wherein the processor is further configured with the logic to record the first media content to non-buffer space on a medium in a storage device.

46. The system of claim 35, wherein the processor is further configured with the logic to receive the first media content and the second media content from a remote server.

47. The system of claim 35, wherein the processor is further configured with the logic to receive the first media content and the second media content from a local computer.

48. The system of claim 35, wherein the processor is further configured with the logic to provide a user interface for providing notice to the user of the second media content and providing the option of receiving the second media content and not receiving the second media content.

49. The system of claim 48, wherein the displayed notice can be enabled and disabled by the user.

50. The system of claim 35, wherein the processor is further configured with the logic to store a storage medium location of the first media content, where the transition to the second media content began, in memory.

51. The system of claim 50, wherein the location is a handle and a real-time clock value.

52. The system of claim 50, wherein the location is a handle and a pointer value.

53. The system of claim 35, wherein the processor is further configured with the logic to store a memory address of the first media content, where the transition to the second media content began, in memory.

54. The system of claim 35, wherein the processor is further configured with the logic to transition from the second media content to third media content.

55. The system of claim 35, wherein the first media content is broadcast media content.

56. The system of claim 35, wherein the first media content is web-content.

57. The system of claim 35, wherein the second media content is broadcast media content.

58. The system of claim 35, wherein the second media content is web-content.

59. The system of claim 35, wherein the processor is further configured with the logic to receive user commands to transition.

60. The system of claim 35, wherein the processor is further configured with the logic to receive instructions associated with the first media content that the second media content is available at a specified location.

61. The system of claim 60, wherein the instructions are verbal instructions from a commentator presenting in the first media content.

62. The system of claim 60, wherein the instructions are symbol instructions displayed in the display of the first media content.

63. The system of claim 60, wherein the specified location is a web address.

64. The system of claim 60, wherein the specified location is a media content stream.

65. The system of claim 35, wherein the processor is further configured with the logic to provide a user interface on a screen display that indicates where in playing back the recorded first media content the user is relative to the real-time currently tuned location.

66. The system of claim 35, wherein the processor is further configured with the logic to display the second media content while recording the first media content.

67. The system of claim 35, wherein the processor and the memory are located in a media client device.

68. The system of claim 35, wherein the processor and the memory are located in a remote service.

69. A media system on a recordable medium, comprising logic configured to transition from first media content to second media content, wherein the logic is further configured with logic to record the first media content responsive to transitioning to the second media content.

70. The media system of claim 69, wherein the logic is further configured to automatically play back the recorded first media content upon exiting the second media content.

71. The media system of claim 69, wherein the logic is further configured to provide a user interface, after exiting the second media content, that presents viewing options.

72. The media system of claim 71, wherein the viewing options includes playing back from the beginning of the recorded first content, returning to the real-time location of currently tuned media content, and transitioning to third media content.

73. The media system of claim 69, wherein the logic is further configured to display the second media content while recording the first media content.
